(19) United States
(12) Patent Application Publication
(10) Pub. No.: US 2019/0084796 A1
(43) Pub. Date: Mar. 21, 2019

(54) RESTRICTED ACCESS AREA SAFETY SYSTEM

(71) Applicant: Otis Elevator Company, Farmington, CT (US)

(72) Inventors: Craig A. Buckley, Glastonbury, CT (US); Edward Gallup, Westfield, MA (US); Zachary Byler, Bristol, CT (US)

(21) Appl. No.: 15/705,358

(22) Filed: Sep. 15, 2017

(51) Int. Cl. B66B 5/00; B66B 1/28; B66B 1/34; B66B 3/00

(52) U.S. Cl. CPC B66B 5/005; B66B 1/28; B66B 5/0056; B66B 3/002; B66B 1/3461

(57) ABSTRACT

According to one embodiment, a safety system can comprise at least one receiver, each located in a restricted access area; a safe operation monitor coupled to the at least one receiver configured to detect signals from the at least one receiver; wherein: the at least one receiver is configured to receive signals from a transmitter, the transmitter being used by a worker within the restricted access area; the safe operation monitor is configured to protect the restricted access area, based on the receipt of a signal from the transmitter; and causing an alert on the transmitter.

### BACKGROUND

Exemplary embodiments pertain to the art of safety systems. In particular, the present invention relates to a system that contains safety features to protect workers located in a restricted access area.

An elevator system typically includes an elevator car located in a hoistway. The elevator car is moved up and down the hoistway through a variety of different means, including hydraulics, cables, electric motors, and the like. Occasionally, workers may repair or maintain portions of the elevator hoistway, either above or below the elevator car.

### BRIEF DESCRIPTION

According to one embodiment, a safety system can comprise at least one receiver, each located in a restricted access area; a safe operation monitor coupled to the at least one receiver configured to detect signals from the at least one receiver; wherein: the at least one receiver is configured to receive signals from a transmitter, the transmitter being used by a worker within the restricted access area; the safe operation monitor is configured to protect worker within the restricted access area, based on the receipt of a signal from the transmitter.

In addition to one or more features described above, or as an alternative, further embodiments may include wherein the safety system is coupled to an elevator system; the restricted access area is located in an elevator hoistway; and protecting the restricted access area comprises ceasing operation of an elevator car within the elevator system.

In addition to one or more features described above, or as an alternative, further embodiments may include wherein each of the at least one receiver has a unique identifier; and the safe operation monitor uses the unique identifier to determine a location of the transmitter.

In addition to one or more features described above, or as an alternative, further embodiments may include wherein safe operation monitor is further configured to cause an alert on the transmitter.

In addition to features described above, or as an alternative, further embodiments may include each of the at least one receiver is configured to receive radio frequency identification (RFID) signals from a transmitter.

In addition to features described above, or as an alternative, further embodiments may wherein each of the one or more receivers is configured to receive a panic button signal from a transmitter; and the safe operation monitor is configured to cease the operation of the elevator, based on the receipt of the panic button signal from the transmitter.

In addition to features described above, or as an alternative, further embodiments may include wherein each of the at least one receiver is configured to receive short-range signals from a transmitter that indicates the presence of the transmitter in the vicinity of one of the receivers.

In addition to features described above, or as an alternative, further embodiments may include wherein the restricted access area is on an elevator car.

In addition to features described above, or as an alternative, further embodiments may include wherein the restricted access area is at a bottom of an elevator hoistway.

In addition to features described above, or as an alternative, further embodiments may include wherein the alert on the transmitter is configured to continue until a hardware button in the restricted access area is activated.

In addition to features described above, or as an alternative, further embodiments may include at least one mixer coupled to the at least one receiver, wherein the at least mixer is configured to combine a first unique identifier associated with the receiver with a second unique identifier associated with a transmitter, upon the receipt of the signal from the transmitter, to identify a location of the transmitter.

In addition to features described above, or as an alternative, further embodiments may include wherein the safe operation monitor is further configured to resume operation of the elevator upon a removal of the transmitter from the restricted area.

According to one embodiment, a method can comprise receiving a signal from a transmitter indicative of the transmitter being in a restricted access area; determining a location of the transmitter; using the location to protect the restricted access area at the location of the transmitter; and causing an alert on the transmitter.

In addition to features described above, or as an alternative, further embodiments may include wherein determining the location of the transmitter comprises using a unique identifier associated with a receiver.

In addition to features described above, or as an alternative, further embodiments may include wherein receiving the signal comprises receiving a radio frequency identification (RFID) signal from a transmitter.

In addition to features described above, or as an alternative, further embodiments may include wherein receiving comprises receiving a panic button signal from a transmitter.

In addition to features described above, or as an alternative, further embodiments may include wherein receiving comprises receive a short-range signal from a transmitter that indicates the presence of the transmitter in the vicinity of one of the receivers.

In addition to features described above, or as an alternative, further embodiments may include wherein the restricted access area is on an elevator car.

In addition to features described above, or as an alternative, further embodiments may include wherein the restricted access area is at a bottom of an elevator hoistway.

In addition to features described above, or as an alternative, further embodiments may include continuing the alert on the transmitter is configured until a hardware button in the restricted access area is activated.

In addition to features described above, or as an alternative, further embodiments may include wherein protecting the restricted access area comprises ceasing operation of an elevator.

### BRIEF DESCRIPTION OF THE DRAWINGS

The following descriptions should not be considered limiting in any way. With reference to the accompanying drawings, like elements are numbered alike:

FIG. 1 is a stylized illustration of an elevator hoistway;

FIG. 2 is a block diagram of one or more embodiments; and

FIG. 3 is a flowchart illustrating the operation of one or more embodiments.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

In one or more embodiments, a transmitter worn or used by the worker is used in conjunction with a variety of different gear, including a receiver, mixer, collector, and safe operation monitor. When a signal from the transmitter is sensed in a particular location, a variety of different safety features can be activated to protect the worker.

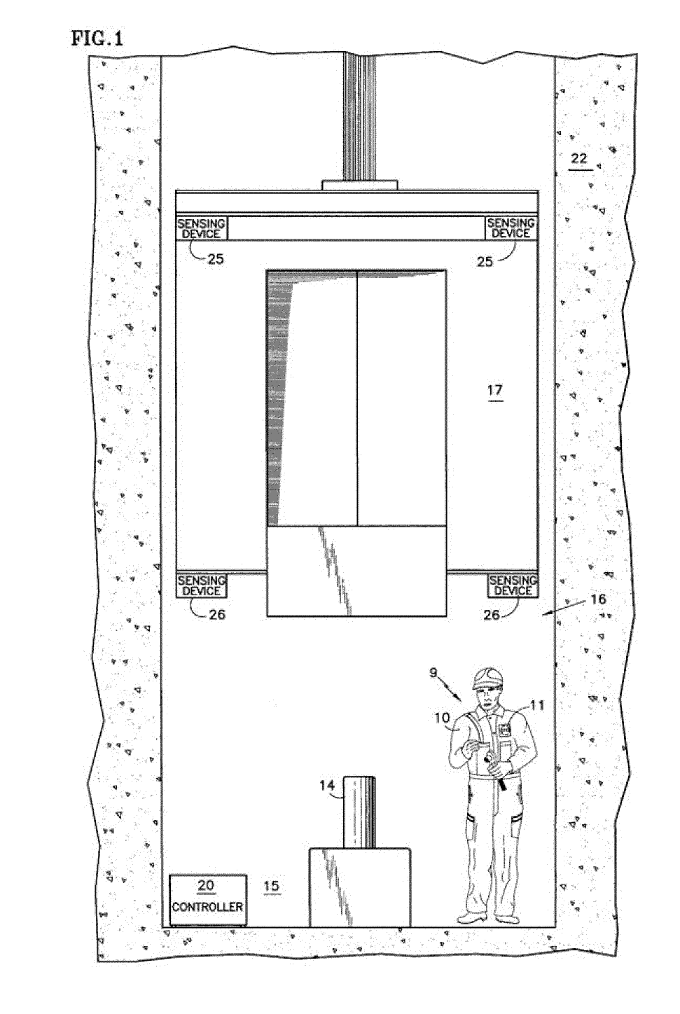

Referring to FIG. 1, an elevator worker 9 is wearing a uniform 10 having a portable transmitter 11, described in greater detail below. In one or more embodiments, the portable transmitter 11 may be worn directly by the worker 9. The worker 9 is standing next to an elevator car buffer 14, in the pit 15 of an elevator hoistway 16, within which an elevator car 17 travels vertically to transport to passengers in a vertical direction. A controller 20 may be disposed within the pit 15, or elsewhere in the building 22, such as in a machine room at the top of the elevator hoistway 16, in any conventional fashion. In accordance with one or more embodiments, at least one of sensing device 25, 26 is disposed at the top and/or the bottom of the elevator car 17.

The transmitter 11 may comprise a transmitter powered by a battery or any other conventional portable powered device. In some embodiments, sensors 25, 26 need only be receivers capable of receiving a signal transmitted from the transmitter 11 when transmitter 11 is in the vicinity of sensors 25, 26.

Typically, when elevator worker 9 proceeds to work in the elevator hoistway or on top of the elevator, elevator worker 9 activates a switch (not shown) that deactivates elevator car 17, thereby preventing the elevator car 17 from moving unexpectedly. However, on rare occasions, the elevator worker 9 may forget to activate the switch when working in the elevator hoistway 16 or on elevator car 17.

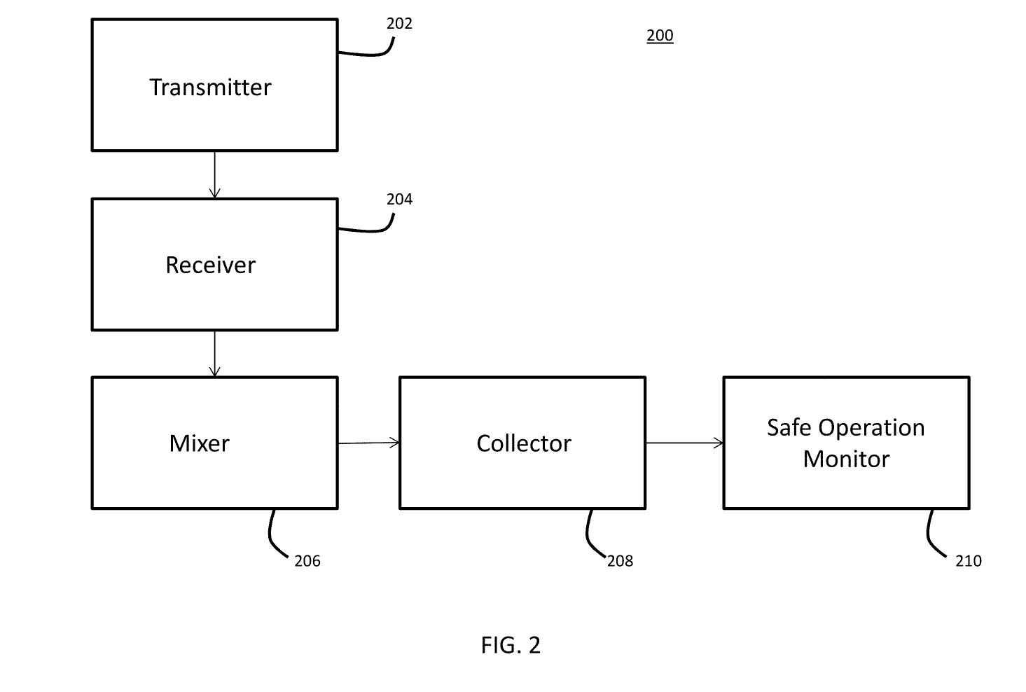

FIG. 2 is a block diagram illustrating components of one or more embodiments. As described earlier, a worker has a transmitter 202. Transmitter 202 can be utilized in one of a variety of different manners. For example, transmitter 202 can utilize radio-frequency identification (RFID) technology to perform transmissions. Other technologies can be used, such as Bluetooth, WiFi, or any other known wireless communication technology. Transmitter 202 can be carried by workers. It can be worn as a lanyard or a wristband. In some embodiments, transmitter 202 can be incorporated into an identification or worn as or behind a badge, or on or as part of a hardhat. Transmitter 202 can be uniquely encoded such that, if multiple transmitters are used, it is known which transmitter is making a transmission that is being received. In some embodiments, transmitter 202 can be coupled to a manually operated switch. For example, a button on a key card can be used. The button can be used as a “panic” button, to be used in an emergency. The use of such a button will be explained in greater detail below.

Receiver 204 was illustrated as sensing device 25 and 26 in FIG. 1. Receiver 204 can be located in any area where a worker would likely be placed, such as at the bottom of an elevator hoistway, on top of an elevator car, or in the area of the motors of the elevator system. Receiver 204 can be a range-limited receiver such that only a signal from a transmitter 202 that is closely located is received. In such a manner, only a transmitter that is actually in a dangerous area will be sensed by receiver 204. In some embodiments, the detection of a transmitter 202 by a receiver 204 can be considered a hoistway access detection (HAD) fault. In general, a HAD fault occurs when a hoistway door is detected to be open on a floor without a corresponding opening of a door of an elevator car. In those situations, the elevator car can be shut down in the presence of the HAD fault.

Mixer 206 is coupled to each receiver 204. It should be understood that multiple receivers are present in a typical elevator system. For example, there can be one or more receivers at the top of each elevator car. There can be one or more receivers at the bottom of each elevator car. There can be one or more receivers at the bottom of the elevator hoistway, each located in an area where a worker will likely be placed. In a manner similar to that described above with respect to the transmitter 202, each receiver 204 can contain a unique identifier. Thus, when an alert signal is generated by receiver 204, mixer 206 can be made aware of which receiver 204 received the signal and which transmitter 202 generated the signal. Mixer 206 can then generate a “mechanic present” alert signal. The signal can be placed at one of a variety of different locations. For example, embodiments used in elevator systems can have the signal placed in the hoistway, in the machine room, or in any location where the signal is likely to be seen or heard by a worker.

Collector 208 is configured to aggregate signals from mixer 206. In embodiments where there are multiple mixers, collector 208 can used to examine all of the signals from the multiple mixers. Collector 208 might not be present in an elevator system that only contains a single mixer 206. In some embodiments, the functions of collector 208 can be performed by mixer 206.

Safe operation monitor 210 is a part of the elevator system that ensures the safe operation of the elevators. Safe operation monitor 210 receives signals from a variety of different sources, both those described herein as well as hardware switches located in the elevator hoistway or on the top of each elevator car. Safe operation monitor 210 can thus monitor which elevator cars are being serviced and which are available for use. If a signal is received from collector 208 indicating the presence of a transmitter 202 in a monitored location, a variety of actions can occur. In some embodiments, the safe operation monitor 210 may perform the functions of one or both of the mixer 206 and collector 208. In some embodiments, signals from the receiver 204 may be transmitted directly to the collector 208 or safe operation monitor 210. In some embodiments, signals from the mixer 206 may be transmitted directly to the collector 208 or safe operation monitor 210.

The coupling between the various blocks shown in FIG. 2 can be made in one or more of a variety of different manners. For example, transmitter 202 can transmit RFID signals and receiver 204 can receive RFID signals. Other wireless protocols can be used for transmitter 202 and receiver 204. In general, any wireless system can be used that provides proximity sensing of signals generated by transmitter 202 by receiver 204. In addition, the “panic” button of transmitter 202 can use one of a variety of different protocols also, either the same as the signals described above or as a longer-distance protocol. In some embodiments, the panic button uses a different transmission protocol, such that signals can be detected from a longer distance. This feature can be useful if, for example, the nearest receiver is out of order. In such a case, the panic button can still protect the worker by preventing the operation of elevator cars within the elevator hoistway. Other elements of FIG. 2 can be coupled together via any wireless or wired protocol.

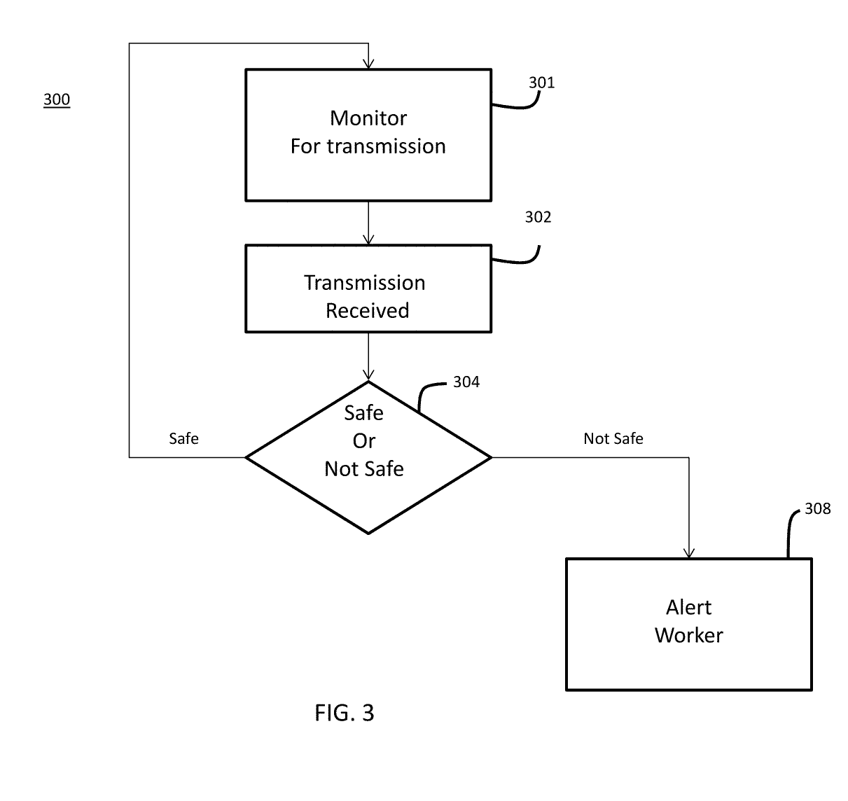

A flowchart illustrating method 300 is presented in FIG. 3. Method 300 is merely exemplary and is not limited to the embodiments presented herein. Method 300 can be employed in many different embodiments or examples not specifically depicted or described herein. In some embodiments, the procedures, processes, and/or activities of method 300 can be performed in the order presented. In other embodiments, one or more of the procedures, processes, and/or activities of method 300 can be combined or skipped. In one or more embodiments, method 300 is performed by a processor as it is executing instructions.

Method 300 is from the perspective of safe operation monitor 210. Transmissions are monitored at block 301. At block 302, a transmission is received from collector 208. As mentioned above, in some embodiments, collector 208 might not be present. In such a case, the alert is received from mixer 206. The transmission may indicate that a transmitter is present in a restricted access area. For example, if a transmitter is in proximity of a receiver, an alert can be generated. The alert can be an indication that a worker may be located in a restricted access area.

It is then determined if the restricted access area is in a safe condition or not (block 304). A safe condition means that the worker has activated the appropriate safety features located in the elevator hoistway or on the elevator car. For example, traditional safe operation for an elevator worker is to activate a safety switch located in the elevator hoistway or on top of the elevator car on which he is working. If the worker has not activated such a switch, the condition can be considered not safe. In such a situation, the worker can be alerted (block 308). In some embodiments, if the safety switch has not been engaged within a prescribed period of time, regardless of an alert to the worker, the elevator car is passively shut down. In order to re-enable the elevator car, manual intervention by the worked would be needed. In some embodiments, the alert is an audible signal that reminds the worker to activate the appropriate switch. In some embodiments, other alerts can be used, such as warning lights that are located in the elevator hoistway or on the elevator car. The alert helps to train workers because the presence of the alert encourages the workers to activate the appropriate safety switches. This behavior can become habit for the workers such that they will be more likely to activate the appropriate safety switches before beginning repairs to the elevator system in the future. The alert can also serve to warn others of the presence of a worker in the restricted access area.

If appropriate precautions were made (such as activating appropriate switches in the elevator hoistway or elevator car), the elevator can be considered to be in a safe condition. The system continues monitoring for safety signals (block 301).

It should be understood that, in both the safe and not safe condition, the operation of the elevator ceases. The transmitter (such as transmitter 202) thus acts as an additional layer of safety—instead of relying solely on manually-operated switches that are located in the elevator hoistway or on the elevator car, a system using one or more embodiments allows redundancy, to provide a safer environment for workers.

It should be understood that, while one or more embodiments above were described with respect to an elevator system, embodiments are not so limited. One or more embodiments can be used in any restricted access area.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A safety system comprising:
at least one receiver, located in a restricted access area;
a safe operation monitor coupled to the one or more receivers configured to detect signals from the at least one receiver; wherein:
the at least one receiver configured to receive signals from a transmitter, the transmitter being used by a worker within the restricted access area; and
the safe operation monitor is configured to protect the worker located in the restricted access area, based on the receipt of a signal from the transmitter.

2. The safety system of claim 1 wherein:
the safety system is coupled to an elevator system;
the restricted access area is located in an elevator hoistway; and
protecting the worker located in the restricted access area comprises ceasing operation of an elevator car within the elevator system.

3. The safety system of claim 2 wherein:
the safe operation monitor is further configured to cause an alert on the transmitter.

4. The safety system of claim 3 wherein:
each of the at least one receiver is configured to receive a panic button signal from a transmitter; and
the safe operation monitor is configured to cease the operation of the elevator, based on the receipt of the panic button signal from the transmitter.

5. The safety system of claim 2 wherein the restricted access area is on an elevator car.

6. The safety system of claim 2 wherein the restricted area is at a bottom of an elevator hoistway.

7. The safety system of claim 2 wherein:
each of the at least one receiver has a unique identifier; and
the safe operation monitor uses the unique identifier to determine a location of the transmitter.

8. The safety system of claim 2 wherein the safe operation monitor is further configured to resume operation of the elevator upon a removal of the transmitter from the restricted area.

9. The safety system of claim 1 wherein:
each of the at least one receiver is configured to receive short-range signals from a transmitter that indicates the presence of the transmitter in the vicinity of one of the at least one receiver.

10. The safety system of claim 1 wherein the alert on the transmitter is configured to continue until a hardware button in the restricted access area is activated.

11. The safety system of claim 1 further comprising at least one mixer coupled to the one or more receivers, wherein the at least one mixer is configured to combine a first unique identifier associated with the at least one receiver with a second unique identifier associated with a transmitter, upon the receipt of the signal from the transmitter, to identify a location of the transmitter.

12. A method comprising:
receiving a signal from a transmitter indicative of the transmitter being in a restricted access area;
determining a location of the transmitter;
using the location to protect a worker located in the restricted access area at the location of the transmitter; and
causing an alert on the transmitter.

13. The method of claim 12 wherein:
determining the location of the transmitter comprises using a unique identifier associated with a receiver.

14. The method of claim 12 wherein:
receiving the signal comprises receiving a radio frequency identification (RFID) signal from a transmitter.

15. The method of claim 12 wherein receiving comprises receiving a panic button signal from a transmitter.

16. The method of claim 12 wherein receiving comprises receive a short-range signal from a transmitter that indicates the presence of the transmitter in the vicinity of one of the receivers.

17. The method of claim 12 wherein the restricted access area is on an elevator car.

18. The method of claim 12 wherein the restricted access area is at a bottom of an elevator hoistway.

19. The method of claim 12 further comprising continuing the alert on the transmitter is configured until a hardware button in the restricted access area is activated.

20. The method of claim 12 wherein protecting the worker located in the restricted access area comprises ceasing operation of an elevator.
